(19) United States
(12) Patent Application Publication
(10) Pub. No.: US 2025/0304048 A1
(43) Pub. Date: Oct. 2, 2025

(54) VEHICLE CONTROL DEVICE

(71) Applicant: HONDA MOTOR CO., LTD., Tokyo (JP)

(72) Inventors: Shunya ISHIKAWA, Tokyo (JP); Shinya SATO, Tokyo (JP)

(73) Assignee: HONDA MOTOR CO., LTD., Tokyo (JP)

(21) Appl. No.: 19/064,762

(22) Filed: Feb. 27, 2025

(30) Foreign Application Priority Data
Mar. 29, 2024 (JP) 2024-056788

(51) Int. Cl. B60W 30/09; B60W 30/095; B60W 30/14; B60W 50/00; B60W 50/14; G06V 20/58

(52) U.S. Cl. CPC B60W 30/09; B60W 30/0956; B60W 30/146; B60W 50/0097; B60W 50/14; G06V 20/58; B60W 2050/143; B60W 2050/146; B60W 2420/403; B60W 2530/201; B60W 2554/4041; B60W 2554/80

(57) ABSTRACT

A vehicle control device includes: a recognition unit; a first prediction unit; a second prediction unit; and a collision prevention control unit, and if one movement trajectory that is the movement trajectory of one traffic participant among the at least one traffic participant intersects the host vehicle movement trajectory, the collision prevention control unit determines whether an obstacle is present on the one movement trajectory ahead of a first point at which the one movement trajectory intersects the host vehicle movement trajectory, predicts a stop position of the one traffic participant based on a position of the obstacle and the one movement trajectory in a case where the collision prevention control unit determines that the obstacle is present, and executes the collision prevention control in a case the vehicle is determined to have a possibility to collide with the one traffic participant based on the predicted stop position.

### CROSS-REFERENCE TO RELATED APPLICATION

This application is based on and claims priority under 35 USC 119 from Japanese Patent Application No. 2024-056788 filed on Mar. 29, 2024.

### TECHNICAL FIELD

The present invention relates to a vehicle control device.

### BACKGROUND ART

In recent years, active efforts have been made to provide access to a sustainable transportation system in consideration of vulnerable traffic participants. As one of the attempts, research and development on driving assistance technique and automatic driving technique of a moving object (for example, a vehicle such as an automobile) have been performed in order to improve safety and convenience of traffic.

Driving assistance techniques include, for example, deceleration control of decelerating a vehicle and/or collision prevention control (also referred to as “collision mitigation brake system (CMBS)”) of issuing a predetermined alarm to an occupant of the vehicle if it is determined that the vehicle may collide with an obstacle.

Patent Literature 1 below discloses a technique of: identifying a first oncoming vehicle that satisfies both a first condition that a speed of an oncoming vehicle traveling in an oncoming lane is equal to or less than a judgment speed for judging a stop state and a second condition that a trajectory predicted for an oncoming vehicle crosses a course of the host vehicle; performing vehicle control of giving way to the first oncoming vehicle if it is determined that a second oncoming vehicle traveling behind the first oncoming vehicle is present in an oncoming lane; and not performing the vehicle control if it is determined that no second oncoming vehicle is present.

### Patent Literature

Patent Literature 1: JP2021-064033A

### SUMMARY OF INVENTION

However, in the conventional art, there is room for improvement from the viewpoint of appropriately executing the collision prevention control in the vehicle.

The present invention provides a vehicle control device capable of appropriately executing collision prevention control in a vehicle and improving safety of the vehicle. In addition, this improves traffic safety and contributes to development of a sustainable transportation system.

An aspect of the present invention is a vehicle control device for controlling a vehicle, including:
a recognition unit configured to recognize an object present around the vehicle based on peripheral information on the vehicle acquired by an external sensor included in the vehicle;
a first prediction unit configured to, if traffic participants moving around the vehicle are recognized as the object, predict movement trajectories of the traffic participants;
a second prediction unit configured to predict a host vehicle movement trajectory that is a movement trajectory of the vehicle; and
a collision prevention control unit configured to execute collision prevention control based on the predicted movement trajectories of the traffic participants and the host vehicle movement trajectory, in which
if one movement trajectory that is the movement trajectory of one traffic participant among the traffic participants intersects the host vehicle movement trajectory, the collision prevention control unit
   determines whether an obstacle is present on the one movement trajectory ahead of a first point at which the one movement trajectory intersects the host vehicle movement trajectory,
   predicts a stop position of the one traffic participant based on a position of the obstacle and the one movement trajectory if it is determined that the obstacle is present, and
   executes the collision prevention control if it is determined that the vehicle may collide with the one traffic participant based on the predicted stop position.

According to the present invention, it is possible to provide a vehicle control device capable of appropriately executing collision prevention control in a vehicle and improving the safety of the vehicle.

### BRIEF DESCRIPTION OF DRAWINGS

FIG. 1 is a diagram illustrating a vehicle 1 controlled by a control device 30 that is an embodiment of a vehicle control device of the present invention.

FIG. 2 is a diagram illustrating an example of an activation concept of collision prevention control by the control device 30.

FIG. 3 is a diagram illustrating a first example of an operation of the vehicle 1.

FIG. 4 is a timing chart illustrating an example of a more detailed operation of the vehicle 1 in the first example illustrated in FIG. 3.

FIG. 5 is a diagram illustrating a second example and a third example of the operation of the vehicle 1.

### DESCRIPTION OF EMBODIMENTS

Hereinafter, an embodiment of a vehicle control device according to the present invention will be described in detail with reference to the drawings. The drawings are viewed in directions of reference signs. The following embodiment does not limit inventions disclosed in the claims, and not all combinations of features described in the embodiment are necessarily essential for the inventions. Two or more of a plurality of features described in the embodiment may be combined freely. In the following description, the same or similar elements are denoted by the same or similar reference numerals, and a description thereof may be omitted or simplified as appropriate.

### Configuration of Vehicle

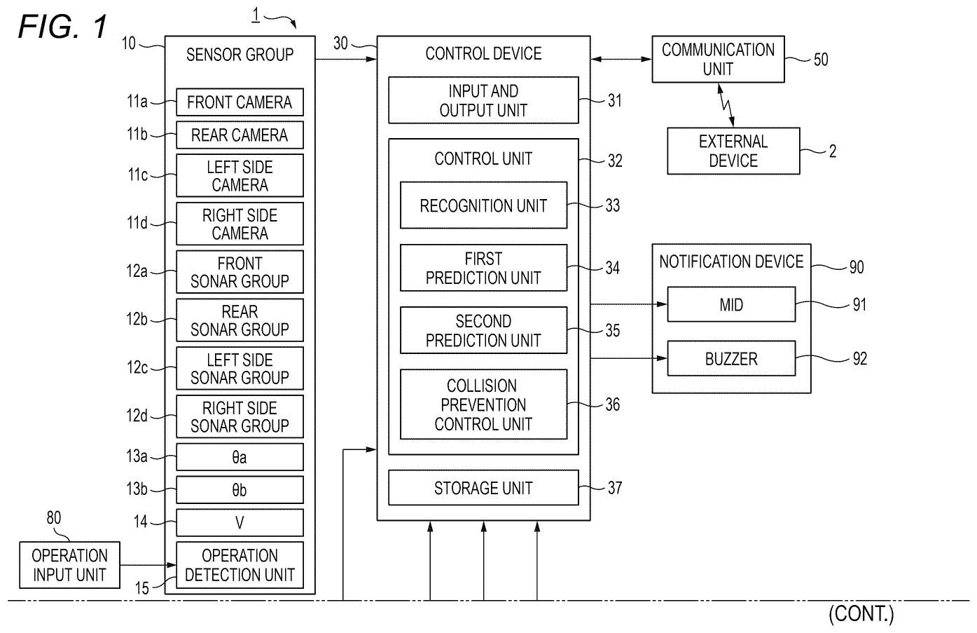

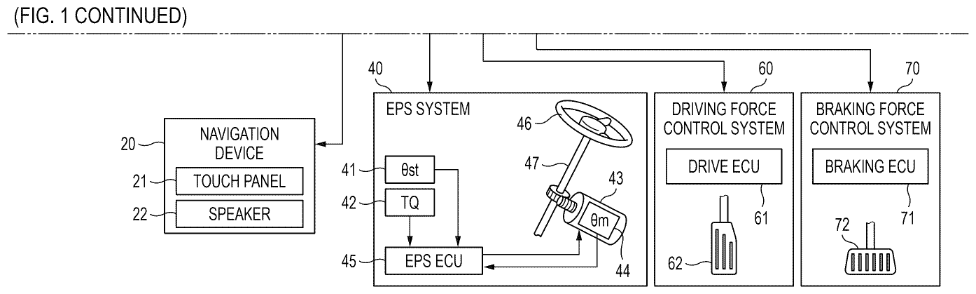

FIG. 1 is a diagram illustrating a vehicle 1 controlled by a control device 30 that is an embodiment of a vehicle control device of the present invention. The vehicle 1 illustrated in FIG. 1 is an automobile including a drive source, and wheels (none illustrated) including drive wheels driven by power of the drive source and steered wheels that can be steered. For example, the vehicle 1 is a four-wheeled automobile including a pair of left and right front wheels and a pair of left and right rear wheels. The drive source of the vehicle 1 may be an electric motor, an internal combustion engine such as a gasoline engine or a diesel engine, or a combination of an electric motor and an internal combustion engine. The drive source of the vehicle 1 may drive the pair of left and right front wheels, the pair of left and right rear wheels, or four wheels including the pair of left and right front wheels and the pair of left and right rear wheels. The front wheels and the rear wheels may all be steerable steered wheels, or the front wheels or the rear wheels may be steerable steered wheels.

As illustrated in FIG. 1, the vehicle 1 includes a sensor group 10, a navigation device 20, a control device 30, an EPS system (electric power steering system) 40, a communication unit 50, a driving force control system 60, a braking force control system 70, an operation input unit 80, and a notification device 90.

The sensor group 10 acquires various detection values related to the vehicle 1 or a surroundings of the vehicle 1. The detection values acquired by the sensor group 10 are sent to the control device 30, and provided for control of the vehicle 1 (for example, collision prevention control to be described later) performed by the control device 30.

The sensor group 10 includes, for example, a front camera 11a, a rear camera 11b, a left side camera 11c, a right side camera 11d, a front sonar group 12a, a rear sonar group 12b, a left side sonar group 12c, and a right side sonar group 12d. These cameras and sonar groups may function as external sensors that acquire peripheral information indicating the surroundings of the vehicle 1.

The front camera 11a, the rear camera 11b, the left side camera 11c, and the right side camera 11d output, to the control device 30, image data of peripheral images obtained by capturing images of the surroundings of the vehicle 1. For example, the front camera 11a, the rear camera 11b, the left side camera 11c, and the right side camera 11d repeatedly capture images around the vehicle 1 at predetermined cycles. The peripheral images captured by the front camera 11a, the rear camera 11b, the left side camera 11c, and the right side camera 11d are also referred to as a front image, a rear image, a left side image, and a right side image, respectively. An image formed by the left side image and the right side image is also referred to as a side image.

The front sonar group 12a, the rear sonar group 12b, the left side sonar group 12c, and the right side sonar group 12d emit sound waves to the surroundings of the vehicle 1 and receive reflected sounds from other object to acquire information including the distance to the other object and the azimuth in which the other object is present (the azimuth based on the vehicle 1).

The front sonar group 12a includes, for example, four sonars. The sonars of the front sonar group 12a are respectively provided on, for example, an obliquely left front side, a front left side, a front right side, and an obliquely right front side of the vehicle 1. The rear sonar group 12b includes, for example, four sonars. The sonars of the rear sonar group 12b are respectively provided on, for example, an obliquely left rear side, a rear left side, a rear right side, and an obliquely right rear side of the vehicle 1. The left side sonar group 12c includes, for example, two sonars. The sonars of the left side sonar group 12c are respectively provided on, for example, a front side of a left side portion and a rear side of a left side portion of the vehicle 1. The right side sonar group 12d includes, for example, two sonars. The sonars of the right side sonar group 12d are respectively provided on, for example, a front side of a right side portion and a rear side of right side portion of the vehicle 1.

Instead of or in addition to the sonar groups 12a, 12b, 12c, and 12d described above, the vehicle 1 may be provided with a radar device that emits radio waves (for example, so-called millimeter radio waves) to the periphery of the vehicle 1 and receives reflected waves from other object to acquire information including the distance to the other object and the azimuth in which the other object is present.

Furthermore, the sensor group 10 includes wheel sensors 13a and 13b, a vehicle speed sensor 14, and an operation detection unit 15. The wheel sensors 13a and 13b detect rotation angles θa and θb of the wheels (not illustrated), respectively. The wheel sensors 13a and 13b may be implemented by angle sensors or may be implemented by displacement sensors. The wheel sensors 13a and 13b output detection pulses each time the wheels rotate at a predetermined angle. The detection pulses output from the wheel sensors 13a and 13b may be used to calculate the rotation angles and rotation speeds of the wheels. A traveling distance of the vehicle 1 may be calculated based on the rotation angles of the wheels. The wheel sensor 13a detects, for example, the rotation angle θa of the left rear wheel. The wheel sensor 13b detects, for example, the rotation angle θb of the right rear wheel.

The vehicle speed sensor 14 detects a travel speed of the vehicle 1, and outputs the detected travel speed of the vehicle 1 to the control device 30. The vehicle speed sensor 14 detects the travel speed of the vehicle 1 based on, for example, rotation of a transmission countershaft.

The operation detection unit 15 detects an operation performed using the operation input unit 80 (for example, an operation of a driver of the vehicle 1), and outputs the detected operation to the control device 30. A part or all of the operation input unit 80 may be shared with an input device of the touch panel 21 described later.

The navigation device 20 identifies a current position of the vehicle 1 using, for example, a global positioning system (GPS) and guides the user on a route from the current position of the vehicle 1 to a destination. The navigation device 20 includes, for example, a storage device (not illustrated) including a map information database.

The navigation device 20 includes a touch panel 21 and a speaker 22. The touch panel 21 is implemented by integrating a display device that can display an image (for example, a liquid crystal display) and an input device that can receive an input of information, and functions as a display device controlled by the control device 30 and an input device that receives an input of various kinds of information to the control device 30. That is, the touch panel 21 displays various screens under the control of the control device 30, and inputs various commands received from the user to the control device 30. The speaker 22 outputs various types of guidance by voice under the control of the control device 30.

The EPS system 40 includes a steering angle sensor 41, a torque sensor 42, an EPS motor 43, a resolver 44, and an electronic control unit (EPS ECU) 45. The steering angle sensor 41 detects a steering angle Ost of a steering 46. The torque sensor 42 detects a torque TQ applied to the steering wheel 46. The EPS motor 43 gives a driving force or a reaction force to a steering column 47 coupled to the steering 46, thereby supporting an operation on the steering 46 (in other words, steering). The resolver 44 detects a rotation angle θm of the EPS motor 43.

The EPS ECU 45 includes, for example, an input and output unit, a calculation unit, and a storage unit (none illustrated), and controls the entire EPS system 40. Further, the EPS ECU 45 outputs information indicating the steering angle θst of the steering 46 detected by the steering angle sensor 41 to the control device 30. Further, the EPS ECU 45 may output information indicating a steering speed ω of the steering 46 to the control device 30. The steering speed ω is obtained by, for example, differentiating the steering angle θst with respect to time.

The communication unit 50 is a communication interface that communicates with an external device 2 under the control performed by the control device 30. That is, the control device 30 can communicate with the external device 2 via the communication unit 50. Examples of the external device 2 can include a terminal device (for example, a smartphone) of the driver and a server device managed by a manufacturer of the vehicle 1. For example, a mobile communication network such as a cellular line, Wi-Fi (registered trademark), Bluetooth (registered trademark), or the like can be adopted for the communication between the vehicle 1 and the external device 2.

The driving force control system 60 includes a drive ECU 61, and can control a driving force of the vehicle 1. The drive ECU 61 includes, for example, an input and output unit, a calculation unit, and a storage unit (none illustrated), and controls the driving force of the vehicle 1 by controlling an internal combustion engine, an electric motor, or the like, which is the drive source of the vehicle 1, based on an operation (hereinafter also referred to as an “accelerator operation”) of the user on an accelerator pedal 62 provided in the vehicle 1 or an instruction from the control device 30.

The braking force control system 70 includes a braking ECU 71 and can control a braking force of the vehicle 1. The braking ECU 71 includes, for example, an input and output unit, a calculation unit, and a storage unit (none illustrated), and controls the braking force of the vehicle 1 by controlling a brake device (not illustrated) of the vehicle 1 based on an operation on a brake pedal 72 provided in the vehicle 1 (hereinafter also referred to as a “brake operation”) or an instruction from the control device 30. The brake device of the vehicle 1 includes, for example, a brake caliper, a cylinder that transmits a hydraulic pressure to the brake caliper, and an electric motor that generates a hydraulic pressure in the cylinder. The braking ECU 71 generates a braking force corresponding to a brake operation by controlling an electric motor of the brake device based on the brake operation or an instruction from the control device 30.

The notification device 90 includes, for example, a multi information display (MID) 91 and a buzzer 92.

An MID 91 is configured with a display device capable of displaying an image (for example, a liquid crystal display), and is provided at a position that can be visually recognized by an occupant seated in the driver's seat of the vehicle 1 (that is, the driver) (for example, in the meter panel of the vehicle 1). The MID 91 displays various screens under the control of the control by the control device 30. As an example, when the control device 30 executes collision prevention control described later, the MID 91 may display a notification image for notifying the driver that the vehicle 1 may collide with an obstacle and/or an instruction to perform a brake operation. The MID 91 may be shared with the display device of the touch panel 21.

The buzzer 92 outputs a predetermined notification sound to the occupant of the vehicle 1 under the control of the control device 30. As an example, when the control device 30 executes the collision prevention control described later, the buzzer 92 outputs, as the notification sound, a predetermined alarm sound indicating that the vehicle 1 may collide with an obstacle. The buzzer 92 may be shared with the speaker 22.

### Control Device

The control device 30 is a device (computer) that integrally controls the entire vehicle 1 based on information input from the sensor group 10, the navigation device 20, the EPS system 40, the communication unit 50, the driving force control system 60, the braking force control system 70, and the like.

The control device 30 includes, for example, an input and output unit 31, a control unit 32, and a storage unit 37. The input and output unit 31 is an interface that inputs and outputs data between the inside and outside of the control device 30 under the control performed by the control unit 32. The storage unit 37 includes, for example, a nonvolatile storage medium such as a flash memory, and stores various types of information (for example, data and programs) for controlling an operation of the vehicle 1.

The control unit 32 includes, for example, a processor such as a central processing unit (CPU), and controls components included in the vehicle 1 by executing programs stored in the storage unit 37 or the like. In the present embodiment, the control unit 32 includes a recognition unit 33, a first prediction unit 34, a second prediction unit 35 and a collision prevention control unit 36 as functional units implemented by the processor executing programs.

The recognition unit 33 recognizes an object around the vehicle 1 and recognizes the position thereof based on the peripheral information acquired by the sensor group 10 (for example, the cameras 11a to 11d and the sonar groups 12a to 12d). For example, the recognition unit 33 recognizes obstacles, road shapes, traffic lights, guard rails, lane marks, traffic participants other than the vehicle 1, and the like and recognizes the positions thereof. Here, examples of the traffic participant include automobiles (including motorcycles) and pedestrians. More specifically, the recognition unit 33 recognizes, for example, a traffic participant such as another vehicle (for example, an oncoming vehicle) or a pedestrian moving around the vehicle 1. If a plurality of traffic participants are present around the vehicle 1, the recognition unit 33 recognizes each of the plurality of traffic participants.

If a traffic participant moving around the vehicle 1 is recognized by the recognition unit 33, the first prediction unit 34 predicts a movement trajectory of the traffic participant (in other words, a route that the traffic participant may move in the future). If a plurality of traffic participants are recognized by the recognition unit 33, the first prediction unit 34 predicts, for example, the movement trajectory of each traffic participant. The movement trajectory of the traffic participant can be predicted based on, for example, one or both of the velocity vector of the traffic participant and the orientation of the traffic participant (more specifically, the direction in which the front of the traffic participant faces).

The second prediction unit 35 predicts a host vehicle movement trajectory that is a movement trajectory of the vehicle 1. The host vehicle movement trajectory can be predicted based on, for example, one or both of the speed vector and the traveling direction of the vehicle 1.

The collision prevention control unit 36 executes the collision prevention control based on the movement trajectory of the traffic participant predicted by the first prediction unit 34 and the host vehicle movement trajectory predicted by the second prediction unit 35. More specifically, the collision prevention control unit 36 executes the collision prevention control if it is determined that the vehicle 1 may collide with one traffic participant based on the predicted movement trajectory of the traffic participant and the host vehicle movement trajectory. For example, the collision prevention control unit 36 may determine that the vehicle 1 may collide with the one traffic participant if one movement trajectory, which is the movement trajectory of the one traffic participant, intersects the host vehicle movement trajectory.

The collision prevention control includes, for example, deceleration control of decelerating the vehicle 1 and/or notification control of performing predetermined notification (for example, notification indicating that collision is possible) to an occupant (for example, the driver) of the vehicle 1 via the notification device 90 included in the vehicle 1. Such collision prevention control is automatically executed if the vehicle 1 may collide with the one traffic participant, so that the vehicle 1 can be prevented from colliding with the one traffic participant, thereby improving the safety of the vehicle 1.

Further, in the present embodiment, if the one movement trajectory, which is the movement trajectory of the one traffic participant, intersects the host vehicle movement trajectory, the collision prevention control unit 36 determines whether an obstacle is present on the one movement trajectory ahead of a first point at which the one movement trajectory intersects the host vehicle movement trajectory. If it is determined that such an obstacle is present, the collision prevention control unit 36 predicts a stop position of the one traffic participant based on the position of the obstacle and the one movement trajectory. Then, the collision prevention control unit 36 executes the collision prevention control if it is determined that the vehicle 1 may collide with the one traffic participant based on a predicted stop position of the one traffic participant (hereinafter, also referred to as a “predicted stop position”).

As an example, in this case, the collision prevention control unit 36 may determine that the vehicle 1 may collide with the one traffic participant on condition that a time to collision (TTC) between the vehicle 1 and the predicted stop position is equal to or less than a threshold. The TTC between the vehicle 1 and the predicted stop position can be obtained, for example, by dividing the distance from the current position of the vehicle 1 to the predicted stop position by the travel speed of the vehicle 1.

That is, if an obstacle is present on the one movement trajectory, the one traffic participant is considered to stop due to the obstacle in the future. Therefore, if an obstacle is present on the one movement trajectory ahead of the first point at which the one movement trajectory intersects the host vehicle movement trajectory, the collision prevention control unit 36 determines whether the vehicle 1 may collide with the one traffic participant based on the predicted stop position at which the one traffic participant may stop due to the obstacle, and executes collision prevention control if it is determined that collision is possible.

According to the configuration of the present embodiment, it is possible to execute the collision prevention control in anticipation that the one traffic participant will stop at the predicted stop position in the future. Thereby, the execution timing of the collision prevention control can be advanced relative to the case where the collision prevention control is executed after the one traffic participant stopped due to the obstacle and the vehicle 1 are likely to actually collide with each other. This can prevent the vehicle 1 from colliding with the one traffic participant from an earlier timing, thereby improving the safety of the vehicle 1. Further, it is possible to improve traffic safety and contribute to development of a sustainable transportation system.

More specifically, for example, if the predicted stop position overlaps the host vehicle movement trajectory, the collision prevention control unit 36 executes the collision prevention control if it is determined that the vehicle 1 may collide with the one traffic participant based on the predicted stop position. Thereby, the execution timing of the collision prevention control can be advanced if the one traffic participant stopped at the predicted stop position and the vehicle 1 may collide with each other.

If it is determined that no obstacle is present on the one movement trajectory ahead of the first point at which the one movement trajectory intersects the host vehicle movement trajectory, the collision prevention control unit 36 executes the collision prevention control if it is determined that the vehicle 1 may collide with the one traffic participant based on the current position of the one traffic participant. That is, in this case, the collision prevention control unit 36 determines whether the vehicle 1 may collide with the one traffic participant based on the current position of the one traffic participant instead of the above-described predicted stop position.

As an example, in this case, the collision prevention control unit 36 may determine that the vehicle 1 may collide with the one traffic participant on condition that the TTC between the vehicle 1 and the one traffic participant is equal to or less than a threshold. The TTC between the vehicle 1 and the one traffic participant can be obtained, for example, by dividing the distance from the current position of the vehicle 1 to the current position of the one traffic participant by the relative speed between the vehicle 1 and the one traffic participant.

As described above, if no obstacle is present on the one movement trajectory and the one traffic participant can proceed smoothly, the control device 30 does advance the execution timing of the collision prevention control, thereby executing the collision prevention control when the one traffic participant and the vehicle 1 may actually collide with each other. This can prevent excessive execution of the collision prevention control.

If an obstacle may be present on the one movement trajectory ahead of the first point in the future, the collision prevention control unit 36 may predict the predicted stop position based on the obstacle and determine whether the vehicle 1 may collide with the one traffic participant based on the predicted stop position.

For example, if a second point at which another movement trajectory, which is the movement trajectory of another traffic participant different from the one traffic participant, intersects the one movement trajectory is present on the one movement trajectory ahead of the first point, the collision prevention control unit 36 may determine that an obstacle is present on the one movement trajectory ahead of the first point. If it is determined that an obstacle is present due to the presence of such a second point, the collision prevention control unit 36 may predict the predicted stop position based on the second point and the one movement trajectory.

According to such a configuration, it is possible to execute the collision prevention control in anticipation that the one traffic participant will stop at the predicted stop position in the future due to another traffic participant that may be present on the one movement trajectory in the future. Thereby, the execution timing of the collision prevention control can be advanced relative to the case where the collision prevention control is executed after the one traffic participant stopped due to the other traffic participant and the vehicle 1 are likely to actually collide with each other. This can prevent the vehicle 1 from colliding with the one traffic participant from an earlier timing, thereby improving the safety of the vehicle 1.

### Activation Concept of Collision Prevention Control

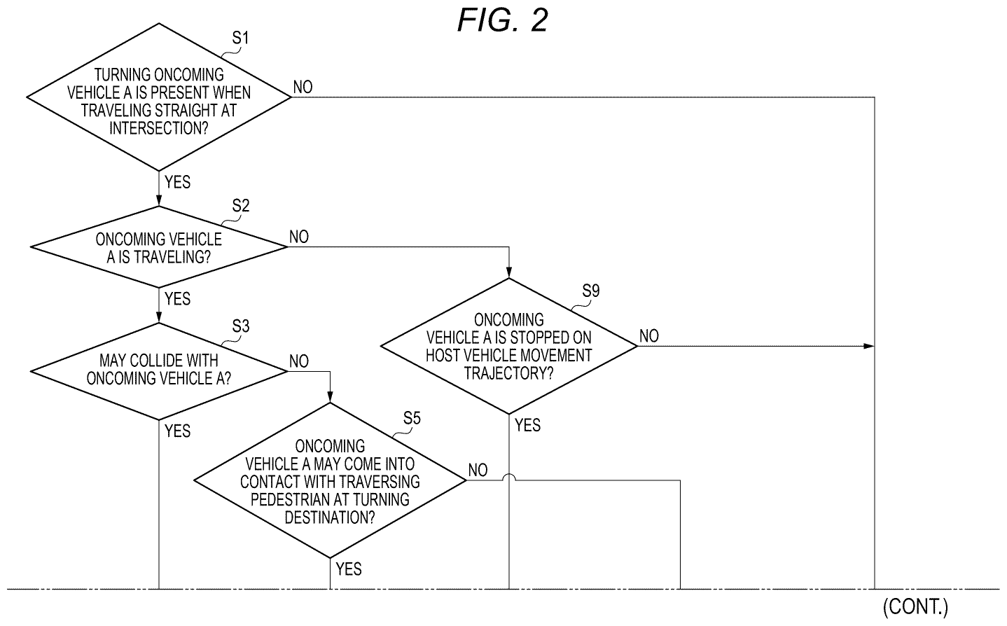

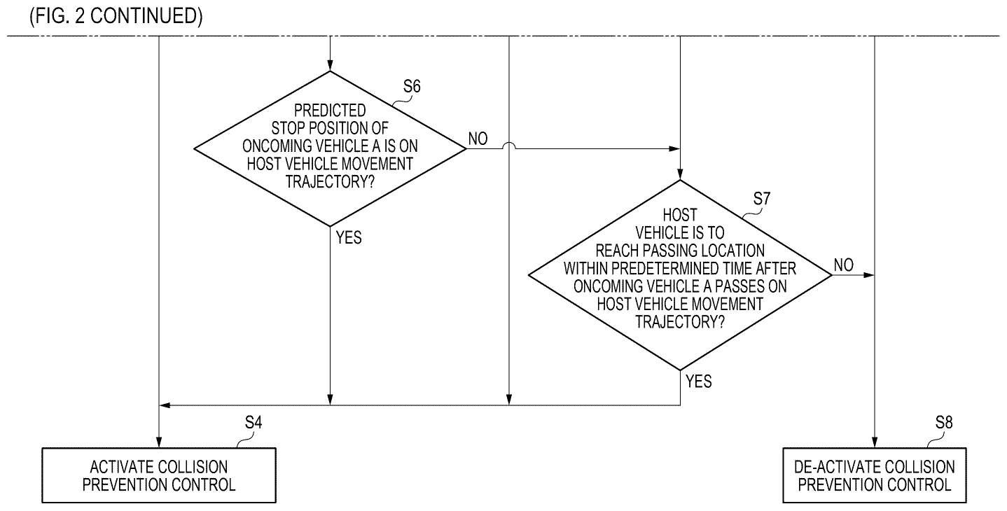

Next, an example of an activation concept of the collision prevention control by the control device 30 will be described with reference to FIG. 2. That is, the control device 30 may execute (that is, activate) the collision prevention control as described below.

For example, it is assumed that when the vehicle 1 travels straight through the intersection, an oncoming vehicle A that is turning (for example, turning right) is present at the intersection (step S1: YES), and the oncoming vehicle A is traveling (for example, the travel speed of the oncoming vehicle A is equal to or higher than 10 [km/h]) (step S2: YES).

In such a case, the control device 30 determines whether the vehicle 1 may collide with the oncoming vehicle A based on, for example, the TTC between the vehicle 1 and the oncoming vehicle A. Then, for example, if it is determined that the vehicle 1 may collide with the oncoming vehicle A due to, for example, the TTC between the vehicle 1 and the oncoming vehicle A being equal to or less than a threshold (step S3: YES), the control device 30 activates the collision prevention control (step S4).

On the other hand, if it is determined that the vehicle 1 will not collide with the oncoming vehicle A at the present time, the control device 30 determines whether the oncoming vehicle A may come into contact with a pedestrian traversing a road as the turning destination (hereinafter, also referred to as “traversing pedestrian”). If it is determined that the oncoming vehicle A may come into contact with the traversing pedestrian at the turning destination (step S5: YES), the control device 30 determines whether the predicted stop position of the oncoming vehicle A due to the traversing pedestrian is on the host vehicle movement trajectory. If it is determined that the predicted stop position of the oncoming vehicle A is on the host vehicle movement trajectory (step S6: YES), the control device 30 activates the collision prevention control (step S4).

If it is determined that the oncoming vehicle A is not to come into contact with the traversing pedestrian at the turning destination (step S5: NO), or if it is determined that the predicted stop position of the oncoming vehicle A is not on the host vehicle movement trajectory (step S6: NO), the control device 30 determines whether the vehicle 1 is to reach a passing location within a predetermined time after the oncoming vehicle A passes on the host vehicle movement trajectory (step S7). If it is determined that the vehicle 1 is to reach the passing location within a predetermined time (for example, 1 [sec]) after the oncoming vehicle A passes (step S7: YES), the control device 30 activates the collision prevention control (step S4).

In other words, the control device 30 (more specifically, the collision prevention control unit 36) activates the collision prevention control if it is predicted that, for example, the movement trajectory of the oncoming vehicle A is to intersect the host vehicle movement trajectory and that the vehicle 1 is to reach the first point, at which the movement trajectory of the oncoming vehicle A intersects the host vehicle movement trajectory, within a predetermined time after the oncoming vehicle A reaches the first point. As described above, by activating the collision prevention control if the vehicle 1 is to reach the passing location within a predetermined time after the oncoming vehicle A passes on the host vehicle movement trajectory, the vehicle 1 can be prevented from excessively approaching the oncoming vehicle A, thereby improving the safety of the vehicle 1. That is, the collision prevention control is executed if the oncoming vehicle A and the vehicle 1 may approach each other below the appropriate interval as described above. This can prevent the oncoming vehicle A and the vehicle 1 from colliding with each other, thereby improving the safety of the vehicle 1.

On the other hand, if the vehicle 1 is to reach the passing location after the predetermined time elapses after the oncoming vehicle A passes on the host vehicle movement trajectory (step S7: NO), the control device 30 does not activate the collision prevention control (step S8). If the vehicle 1 travels straight through the intersection and no turning oncoming vehicle A is present at the intersection (step S1: NO), the control device 30 does not activate the collision prevention control (step S8).

If the oncoming vehicle A is present but the oncoming vehicle A is not traveling (step S2: NO) and the oncoming vehicle A is not stopped on the host vehicle movement trajectory (step S9: NO), the control device 30 does not activate the collision prevention control (step S8). On the other hand, if the oncoming vehicle A is stopped on the host vehicle movement trajectory (step S9: YES), the control device 30 activates the collision prevention control (step S4).

### First Example of Operation of Vehicle

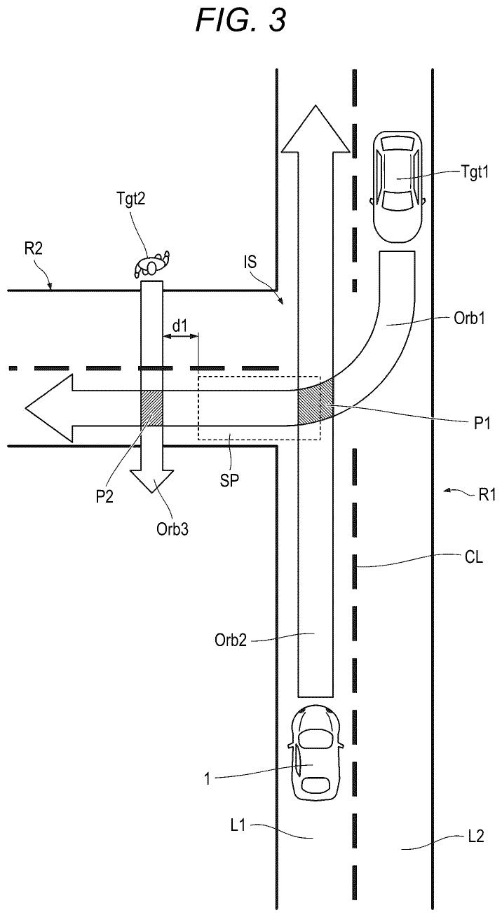

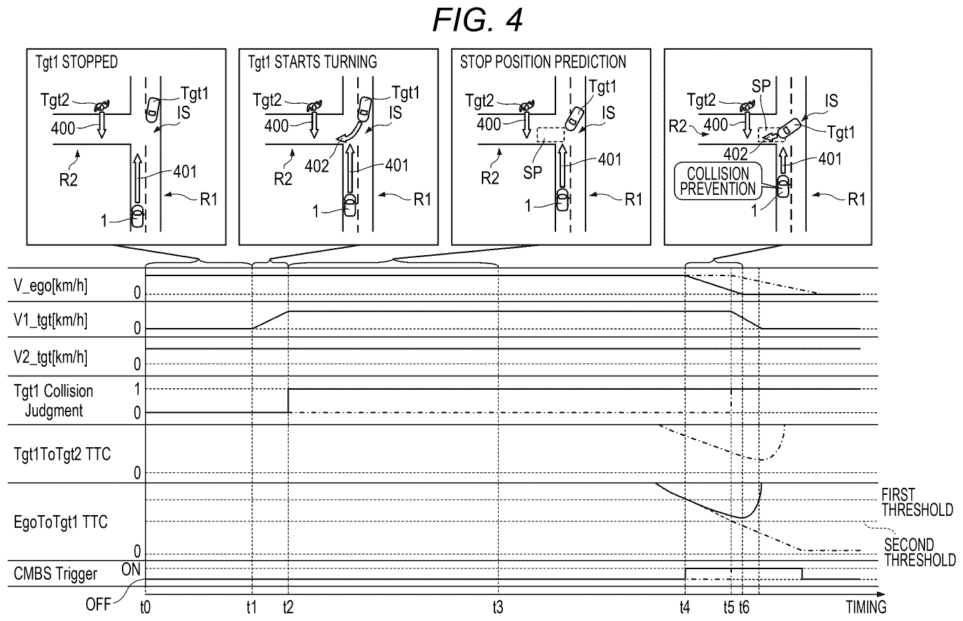

Next, a first example of a specific operation of the vehicle 1 will be described with reference to FIGS. 3 and 4.

In FIG. 3, the road R1 is a road having one lane on each side, including two lanes L1 and L2 partitioned by a central line CL. The vehicle 1 is traveling in one lane L1 from the lower side toward the upper side in FIG. 3. An oncoming vehicle Tgt1 as the one traffic participant is present in the other lane L2. More specifically, in the example illustrated in FIG. 3, an intersection IS is in front of the vehicle 1, and the oncoming vehicle Tgt1 is about to turn right at the intersection IS. A traversing pedestrian Tgt2 as another traffic participant is about to cross the road R2 on which the oncoming vehicle Tgt1 is to travel after turning right.

In such a case, when the vehicle 1 is traveling on the road R1, the control device 30 predicts an other-vehicle movement trajectory Orb1, which is the movement trajectory of the oncoming vehicle Tgt1, and the host vehicle movement trajectory Orb2, which is the movement trajectory of the vehicle 1, and determines whether an obstacle is present on the other-vehicle movement trajectory Orb1 ahead of the first point P1 at which the other-vehicle movement trajectory Orb1 intersects the host vehicle movement trajectory Orb2.

In this example, a second point P2 at which an obstacle movement trajectory Orb3, which is the movement trajectory of the traversing pedestrian Tgt2, intersects the other-vehicle movement trajectory Orb1 is present on the other-vehicle movement trajectory Orb1 ahead of the first point P1. Therefore, the control device 30 determines that an obstacle is present on the other-vehicle movement trajectory Orb1 ahead of the first point P1.

In such a case, the control device 30 predicts a stop position SP of the oncoming vehicle Tgt1 due to the traversing pedestrian Tgt2 (hereinafter, also referred to as a “predicted stop position SP”) based on the second point P2 and the other-vehicle movement trajectory Orb1. For example, in the other-vehicle movement trajectory Orb1, the control device 30 predicts, as the predicted stop position SP, a predetermined area (for example, an area that can include an automobile of a general size) based on a position before the second point P2 by a predetermined distance dl (for example, 1 [m]).

As illustrated in FIG. 3, for example, it is assumed that at least a part of the predicted stop position SP overlaps the host vehicle movement trajectory Orb2. In such a case, the control device 30 activates the collision prevention control if the TTC between the vehicle 1 and the predicted stop position SP is equal to or less than the threshold. More specifically, for example, the control device 30 executes the notification control when the TTC between the vehicle 1 and the predicted stop position SP becomes equal to or less than a first threshold, and executes the deceleration control in addition to the notification control when the TTC becomes equal to or less than a second threshold smaller than the first threshold. These thresholds are set in advance by the manufacturer of the vehicle 1, for example.

As described above, if the oncoming vehicle Tgt1 may come into contact with the traversing pedestrian Tgt2 at the turning destination, the collision prevention control is activated based on the TTC between the vehicle 1 and the predicted stop position SP of the oncoming vehicle Tgt1 due to the traversing pedestrian Tgt2 becoming equal to or less than the threshold. This can advance the execution timing of the collision prevention control relative to the case where the collision prevention control is activated after the oncoming vehicle Tgt1 stopped at the predicted stop position SP and the vehicle 1 are likely to actually collide with each other. In other words, the collision prevention control can be activated in anticipation that the oncoming vehicle Tgt1 will stop at the predicted stop position SP in the future. This can prevent the vehicle 1 from colliding with the oncoming vehicle Tgt1 from an earlier timing, thereby improving the safety of the vehicle 1.

On the other hand, if it is determined that no obstacle is present on the other-vehicle movement trajectory Orb1, such as if no traversing pedestrian Tgt2 is present, the control device 30 activates the collision prevention control if, for example, the TTC between the vehicle 1 and the oncoming vehicle Tgt1 becomes equal to or less than the threshold. That is, if there is no obstacle on the other-vehicle movement trajectory Orb1, it is considered that the oncoming vehicle Tgt1 proceeds smoothly without stopping (turns right in the example illustrated in FIG. 3). Therefore, in such a case, the control device 30 activates the collision prevention control at the same timing as in the conventional art. This can prevent the collision between the vehicle 1 and the oncoming vehicle Tgt1 while preventing excessive activation of the collision prevention control.

FIG. 4 is a timing chart illustrating an example of a more detailed operation of the vehicle 1 (in other words, the control device 30) in the first example illustrated in FIG. 3.

In FIG. 4, V_ego is the travel speed of the vehicle 1. V1_tgt is the travel speed of the oncoming vehicle Tgt1. V2_tgt is the movement speed of the traversing pedestrian Tgt2. Tgt1 Collision Judgment is a collision judgment flag between the oncoming vehicle Tgt1 and the obstacle (here, the traversing pedestrian Tgt2). Tgt1ToTgt2 TTC is the TTC between the oncoming vehicle Tgt1 and the traversing pedestrian Tgt2. EgoToTgt1 TTC is the TTC between the vehicle 1 and the oncoming vehicle Tgt1 (if, for example, Tgt1 Collision Judgment is “0”) or the predicted stop position SP (if, for example, Tgt1 Collision Judgment is “1”). CMBS Trigger is an activation trigger of the collision prevention control. In FIG. 4, a solid line in each item represents an example according to the present embodiment, and an alternate long and short dash line in each item represents a related example.

In a period from a timing t0 to a timing t1, the oncoming vehicle Tgt1 is stopped at the intersection IS (for example, a so-called “waiting to turn right” state). The traversing pedestrian Tgt2 is moving as indicated by an arrow 400, and the vehicle 1 is traveling as indicated by an arrow 401.

At the timing t1, the oncoming vehicle Tgt1 starts turning (for example, turning right) (see an arrow 402 in FIG. 4), and thus V1_tgt which is the travel speed of the oncoming vehicle Tgt1 becomes larger than 0 [km/h]. Thereafter, at a timing t2, if the turning oncoming vehicle Tgt1 becomes equal to or higher than the predetermined speed, the control device 30 determines whether the other-vehicle movement trajectory Orb1 of the turning oncoming vehicle Tgt1 intersects the obstacle movement trajectory Orb3 of the traversing pedestrian Tgt2 (in other words, whether an obstacle is present on the other-vehicle movement trajectory Orb1). If it is determined that the other-vehicle movement trajectory Orb1 intersects the obstacle movement trajectory Orb3, the control device 30 raises (for example, sets to “1”) the collision judgment flag (Tgt1 Collision Judgment) between the oncoming vehicle Tgt1 and the obstacle.

When the collision judgment flag between the oncoming vehicle Tgt1 and the obstacle is raised in this way, the control device 30 predicts the predicted stop position SP of the oncoming vehicle Tgt1. In the example illustrated in FIG. 4, the control device 30 performs a processing of predicting the predicted stop position SP during a period from the timing t2 to a timing t3.

When the predicted stop position SP is predicted, the control device 30 calculates the TTC between the vehicle 1 and the predicted stop position SP, and determines whether the TTC becomes equal to or less than a first threshold, and further, becomes equal to or less than a second threshold.

In the example illustrated in FIG. 4, the TTC between the vehicle 1 and the predicted stop position SP is equal to or less than the first threshold at a timing t4, and thus the control device 30 turns on the activation trigger (CMBS Trigger) of the collision prevention control. Therefore, the control device 30 activates the notification control of the collision prevention control from the timing t4. As described above, the control device 30 can execute the collision prevention control (here, the notification control) from the timing t4 in anticipation that the oncoming vehicle Tgt1 will stop at the predicted stop position SP due to the traversing pedestrian Tgt2 in the future.

In the example illustrated in FIG. 4, the driver immediately starts a braking operation in response to the notification (alarm) by the notification control from the timing t4, and thus the travel speed V_ego of the vehicle 1 decreases immediately after the timing t4. As a result, the vehicle 1 stops at a timing t6 and the collision between the vehicle 1 and the oncoming vehicle Tgt1 is avoided without EgoToTgt1 TTC, which is the TTC between the vehicle 1 and the oncoming vehicle Tgt1, becoming equal to or less than the second threshold (that is, without performing the deceleration control).

On the other hand, in the case of the related example, the activation trigger (CMBS Trigger) of the collision prevention control is not established until a timing t5 at which the TTC between the oncoming vehicle Tgt1 actually stopped at the predicted stop position SP and the vehicle 1 becomes equal to or less than the first threshold. Therefore, as compared to the example of the present embodiment, the start of the collision prevention control is delayed, and for example, the TTC between the vehicle 1 and the oncoming vehicle Tgt1 is likely to be equal to or less than the second threshold (that is, the deceleration control is likely to occur).

As described above, the example of the present embodiment can advance the execution timing of the collision prevention control relative to the case where the collision prevention control is executed after the oncoming vehicle Tgt1 and the vehicle 1 are likely to actually collide with each other as in the related example, thereby improving the safety of the vehicle 1.

### Second Example and Third Example of Operation of Vehicle

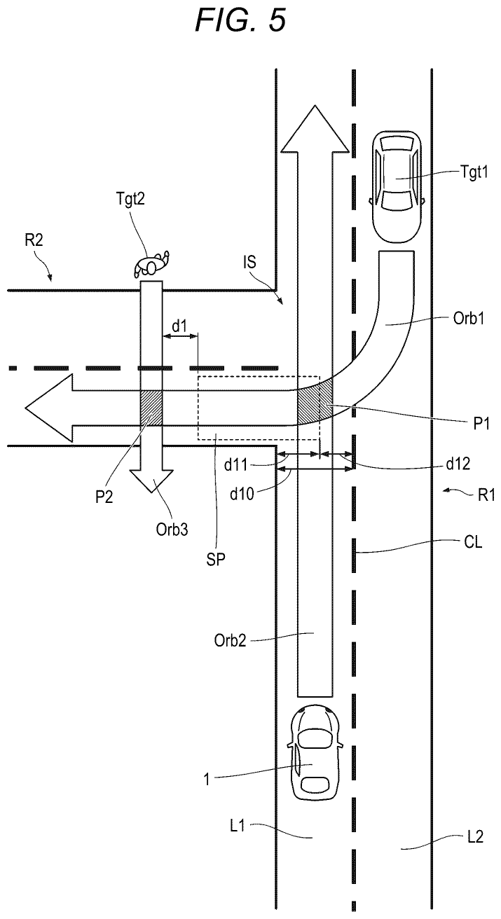

Next, a second example and a third example of the operation of the vehicle 1 will be described with reference to FIG. 5. In the following description, portions different from those in the above-described first example will be mainly described, and description of portions common to those in the above-described first example will be appropriately omitted or simplified. The operations of the oncoming vehicle Tgt1 and the traversing pedestrian Tgt2 in the second example and the third example are the same as those in the first example.

In FIG. 5, d10 is the width of the lane L1 in which the vehicle 1 travels at a portion where the predicted stop position SP overlaps the host vehicle movement trajectory Orb2. In addition, d11 is a distance from a left end L1a of the lane L1 to a right end SPa of the predicted stop position SP, in other words, a distance in the width direction of a portion where the lane L1 overlaps the predicted stop position SP. Moreover, d12 is a distance from the right end SPa of the predicted stop position SP to the central line CL of the road R1, in other words, a distance obtained by subtracting the d11, which is the distance in the width direction of the portion where the lane L1 overlaps the predicted stop position SP, from the width d10 of the lane L1 (that is, d12=d10−d11).

In the second example and the third example, similarly to the first example described above, when the vehicle 1 is traveling on the road R1, for example, the control device 30 predicts the other-vehicle movement trajectory Orb1 and the host vehicle movement trajectory Orb2. If the other-vehicle movement trajectory Orb1 intersects the host vehicle movement trajectory Orb2, the control device 30 determines whether an obstacle such as the second point P2 intersecting the obstacle movement trajectory Orb3 is present on the other-vehicle movement trajectory Orb1 ahead of the first point P1 at which the other-vehicle movement trajectory Orb1 intersects the host vehicle movement trajectory Orb2. If it is determined that such an obstacle is present, the control device 30 predicts the predicted stop position SP of the oncoming vehicle Tgt1.

As a second example, the control device 30 (more specifically, the collision prevention control unit 36) may execute the collision prevention control if it is determined that the vehicle 1 may collide with the oncoming vehicle Tgt1 based on the predicted stop position SP if d10 is equal to or less than a predetermined value. More specifically, the control device 30 may execute the collision prevention control based on the TTC between the vehicle 1 and the predicted stop position SP if d10 is equal to or less than the predetermined value, and may execute the collision prevention control based on the TTC between the vehicle 1 and the oncoming vehicle Tgt1 if d10 is larger than the predetermined value. Here, the predetermined value is, for example, a value sufficiently larger than the dimension D of the vehicle 1 in the vehicle width direction.

That is, if d10 is equal to or less than the predetermined value, it is considered that the lane L1 does not have a space for the vehicle 1 to avoid the oncoming vehicle Tgt1 stopped at the predicted stop position SP. Thereby, the execution timing of the collision prevention control can be advanced in such a case, thereby improving the safety of the vehicle 1. On the other hand, if d10 is sufficiently larger than the dimension D of the vehicle 1 in the vehicle width direction (that is, d10>>D), it is considered that the lane L1 has a space for the vehicle 1 to avoid the oncoming vehicle Tgt1 stopped at the predicted stop position SP. Thereby, the execution timing of the collision prevention control can be prevented from being advanced in such a case, thereby preventing excessive execution of the collision prevention control.

As a third example, the control device 30 (more specifically, the collision prevention control unit 36) may execute the collision prevention control if it is determined that the vehicle 1 may collide with the oncoming vehicle Tgt1 based on the predicted stop position SP if d12 is equal to or less than a predetermined value. More specifically, the control device 30 may execute the collision prevention control based on the TTC between the vehicle 1 and the predicted stop position SP if d12 is equal to or less than the predetermined value, and may execute the collision prevention control based on the TTC between the vehicle 1 and the oncoming vehicle Tgt1 if d12 is larger than the predetermined value. Here, the predetermined value is set in advance based on, for example, the dimension D of the vehicle 1 in the vehicle width direction, and specific examples thereof include a value obtained by adding a predetermined margin (for example, 50 [cm]) to the dimension D of the vehicle 1 in the vehicle width direction.

That is, if d12 is equal to or less than the predetermined value, it is considered difficult for the vehicle 1 to travel while avoiding the oncoming vehicle Tgt1 stopped at the predicted stop position SP without protruding from the lane L1. Thereby, the execution timing of the collision prevention control can be advanced in such a case, thereby improving the safety of the vehicle 1. On the other hand, if d12 is sufficiently large (for example, d12>D), it is considered that the vehicle 1 can travel while avoiding the oncoming vehicle Tgt1 stopped at the predicted stop position SP without protruding from the lane L1. Thereby, the execution timing of the collision prevention control can be prevented from being advanced in such a case, thereby preventing excessive execution of the collision prevention control.

Although one embodiment of the present invention has been described, it goes without saying that the present invention is not limited to this embodiment. It is apparent that those skilled in the art can conceive of various modifications and alterations within the scope described in the claims, and it is understood that such modifications and alterations naturally fall within the technical scope of the present invention. Further, the constituent elements in the embodiment described above may be combined freely in a scope not departing from the gist of the invention.

For example, in the above-described embodiment, a four-wheeled automobile is used as an example of the vehicle, but the present invention is not limited thereto. A vehicle to which the technique of the present disclosure can be applied may be a two-wheeled automobile (so-called motorcycle).

In the present specification, at least the following matters are described. Corresponding constituent elements and the like in the embodiment described above are shown in parentheses, but the present invention is not limited thereto.

(1) A vehicle control device (control device 30) for controlling a vehicle (vehicle 1), including:
a recognition unit (recognition unit 33) configured to recognize object present around the vehicle based on peripheral information on the vehicle acquired by an external sensor (sensor group 10) included in the vehicle;
a first prediction unit (first prediction unit 34) configured to, if traffic participants (oncoming vehicle A, oncoming vehicle Tgt1, traversing pedestrian Tgt2) moving around the vehicle are recognized as the object, predict movement trajectories (other-vehicle movement trajectory Orb1, obstacle movement trajectory Orb3) of the traffic participants;
a second prediction unit (second prediction unit 35) configured to predict a host vehicle movement trajectory (host vehicle movement trajectory Orb2) that is a movement trajectory of the vehicle; and
a collision prevention control unit (collision prevention control unit 36) configured to execute collision prevention control based on the predicted movement trajectories of the traffic participants and the host vehicle movement trajectory, in which
if one movement trajectory (other-vehicle movement trajectory Orb1) that is the movement trajectory of one traffic participant among the traffic participants intersects the host vehicle movement trajectory, the collision prevention control unit
   determines whether an obstacle (obstacle movement trajectory Orb3) is present on the one movement trajectory ahead of a first point (first point P1) at which the one movement trajectory intersects the host vehicle movement trajectory,
   predicts a stop position (predicted stop position SP) of the one traffic participant based on a position of the obstacle and the one movement trajectory if it is determined that the obstacle is present, and
   executes the collision prevention control if it is determined that the vehicle may collide with the one traffic participant based on the predicted stop position.

If an obstacle is present on the one movement trajectory which is the movement trajectory of the moving one traffic participant, the one traffic participant is considered to stop due to the obstacle in the future. According to (1), if it is determined that the one movement trajectory intersects the host vehicle movement trajectory and an obstacle is present on the one movement trajectory ahead of the first point at which the one movement trajectory intersects the host vehicle movement trajectory, the stop position of the one traffic participant based on the obstacle is predicted, and the collision prevention control is executed if it is determined that the vehicle may collide with the one traffic participant based on the stop position. Accordingly, the collision prevention control can be executed in anticipation that the one traffic participant will stop at the stop position based on the obstacle on the one movement trajectory in the future. This can advance the execution timing of the collision prevention control relative to the case where the collision prevention control is executed after the one traffic participant stopped at the stop position is likely to actually collide with the vehicle, thereby improving the safety of the vehicle. Further, it is possible to improve traffic safety and contribute to development of a sustainable transportation system.

(2) The vehicle control device according to (1), in which
the collision prevention control unit
   determines that the obstacle is present if a second point (second point P2) at which another movement trajectory (obstacle movement trajectory Orb3) that is the movement trajectory of another traffic participant among the traffic participants intersects the one movement trajectory is present on the one movement trajectory ahead of the first point, and
   predicts the stop position based on the second point and the one movement trajectory if it is determined that the obstacle is present due to the presence of the second point.

According to (2), the collision prevention control can be executed in anticipation that the one traffic participant will stop in the future at the stop position due to another traffic participant that may be present on the one movement trajectory. This can advance the execution timing of the collision prevention control, thereby improving the safety of the vehicle.

(3) The vehicle control device according to (1) or (2), in which
if it is determined that the obstacle is not present, the collision prevention control unit executes the collision prevention control if it is determined that the vehicle may collide with the one traffic participant based on a current position of the one traffic participant.

According to (3), if no obstacle is present on the one movement trajectory and it is considered that the one traffic participant can proceed smoothly, the execution timing of the collision prevention control can be prevented from being advanced, thereby preventing excessive execution of the collision prevention control.

(4) The vehicle control device according to any one of (1) to (3), in which
if the stop position overlaps the host vehicle movement trajectory, the collision prevention control unit executes the collision prevention control if it is determined that the vehicle may collide with the one traffic participant based on the stop position.

According to (4), the execution timing of the collision prevention control can be advanced if the one traffic participant stopped at the stop position and the vehicle may collide with each other.

(5) The vehicle control device according to (4), in which
if a distance (d12) obtained by subtracting a portion (d11) overlapping the stop position from a width (d10) of a lane (lane L1) in which the vehicle travels at a position where the stop position overlaps the host vehicle movement trajectory is equal to or less than a predetermined value, the collision prevention control unit executes the collision prevention control if it is determined that the vehicle may collide with the one traffic participant based on the stop position.

According to (5), if the distance obtained by subtracting the portion overlapping the stop position from the width of the lane in which the vehicle travels at the position where the stop position overlaps the host vehicle movement trajectory is equal to or less than the predetermined value, it is considered difficult for the vehicle to avoid the one traffic participant stopped at the stop position without protruding from the lane. According to (5), the execution timing of the collision prevention control can be advanced in such a case, thereby improving the safety of the vehicle.

(6) The vehicle control device according to (5), in which
the predetermined value is set based on a dimension (D) of the vehicle in a vehicle width direction.

According to (6), if the distance obtained by subtracting the portion overlapping the stop position from the width of the lane in which the vehicle travels at the position where the stop position overlaps the host vehicle movement trajectory is equal to or less than the predetermined value set based on the dimension of the vehicle in the vehicle width direction, it is considered difficult for the vehicle to avoid the one traffic participant stopped at the stop position without protruding from the lane. According to (6), the execution timing of the collision prevention control can be advanced in such a case, thereby improving the safety of the vehicle.

(7) The vehicle control device according to any one of (1) to (6), in which
the collision prevention control includes deceleration control of decelerating the vehicle and/or notification control of performing predetermined notification to an occupant of the vehicle via a notification device provided in the vehicle.

According to (7), if it is determined that the vehicle may collide with the one traffic participant, the collision prevention control including the deceleration control of decelerating the vehicle and/or the notification control of performing the predetermined notification to the occupant of the vehicle via the notification device provided in the vehicle is executed. This can prevent the vehicle from colliding with the one traffic participant, thereby improving the safety of the vehicle.

(8) The vehicle control device according to any one of (1) to (7), in which
the collision prevention control unit further executes the collision prevention control if it is predicted that the one movement trajectory is to intersect the host vehicle movement trajectory and that the vehicle is to reach the first point within a predetermined time after the one traffic participant reaches the first point.

The one traffic participant and the vehicle may approach each other below an appropriate interval if it is predicted that the one movement trajectory is to intersect the host vehicle movement trajectory and that the vehicle is to reach the first point, at which the one movement trajectory intersects the host vehicle movement trajectory, within a predetermined time after the one traffic participant reaches the first point. According to (8), the collision prevention control is executed if the one traffic participant and the vehicle may approach each other below the appropriate interval as described above. This can prevent the one traffic participant and the vehicle from colliding with each other, thereby improving the safety of the vehicle.

### REFERENCE SIGNS LIST

1 vehicle
10 sensor group (external sensor)
30 control device (vehicle control device)
33 recognition unit
34 first prediction unit
35 second prediction unit
36 collision prevention control unit
D dimension
d10 width
L1 lane
Orb1 other-vehicle movement trajectory (one movement trajectory)
Orb2 host vehicle movement trajectory
Orb3 obstacle movement trajectory (other movement trajectory)
P1 first point
P2 second point
SP predicted stop position (stop position)
Tgt1 oncoming vehicle (traffic participant)
Tgt2 traversing pedestrian (obstacle)

What is claimed is:

1. A vehicle control device for controlling a vehicle, comprising:
a recognition unit configured to recognize an object present around the vehicle based on peripheral information on the vehicle acquired by an external sensor included in the vehicle;
a first prediction unit configured to, in a case where at least one traffic participant moving around the vehicle is recognized as the object, predict a movement trajectory of the at least one traffic participant;
a second prediction unit configured to predict a host vehicle movement trajectory that is a movement trajectory of the vehicle; and
a collision prevention control unit configured to execute collision prevention control based on the predicted movement trajectory of the at least one traffic participant and the host vehicle movement trajectory, wherein
in a case where one movement trajectory that is the movement trajectory of one traffic participant among the at least one traffic participant intersects the host vehicle movement trajectory, the collision prevention control unit
determines whether an obstacle is present on the one movement trajectory ahead of a first point at which the one movement trajectory intersects the host vehicle movement trajectory,
predicts a stop position of the one traffic participant based on a position of the obstacle and the one movement trajectory in a case where the collision prevention control unit determines that the obstacle is present, and
executes the collision prevention control in a case the vehicle is determined to have a possibility to collide with the one traffic participant based on the predicted stop position.

2. The vehicle control device according to claim 1, wherein
the collision prevention control unit
determines that the obstacle is present in a case where a second point at which another movement trajectory that is the movement trajectory of another traffic participant among the at least one traffic participant intersects the one movement trajectory is present on the one movement trajectory ahead of the first point, and
predicts the stop position based on the second point and the one movement trajectory in a case where the collision prevention control unit determines that the obstacle is present due to the presence of the second point.

3. The vehicle control device according to claim 1, wherein
in a case where the collision prevention control unit determines that the obstacle is not present, the collision prevention control unit executes the collision prevention control in a case where the vehicle is determined to have a possibility to collide with the one traffic participant based on a current position of the one traffic participant.

4. The vehicle control device according to claim 1, wherein
in a case where the stop position overlaps the host vehicle movement trajectory, the collision prevention control unit executes the collision prevention control in a case where the vehicle is determined to have a possibility to collide with the one traffic participant based on the stop position.

5. The vehicle control device according to claim 4, wherein
in a case where a distance obtained by subtracting a portion overlapping the stop position from a width of a lane wherein the vehicle travels at a position where the stop position overlaps the host vehicle movement trajectory is equal to or less than a predetermined value, the collision prevention control unit executes the collision prevention control in a case where the vehicle is determined to have a possibility to collide with the one traffic participant based on the stop position.

6. The vehicle control device according to claim 5, wherein
the predetermined value is set based on a dimension of the vehicle in a vehicle width direction.

7. The vehicle control device according to claim 1, wherein
the collision prevention control includes at least one of: deceleration control of decelerating the vehicle; and notification control of performing predetermined notification to an occupant of the vehicle via a notification device provided in the vehicle.

8. The vehicle control device according to claim 1, wherein
the collision prevention control unit further executes the collision prevention control in a case where it is predicted that the one movement trajectory is to intersect the host vehicle movement trajectory and the vehicle is to reach the first point within a predetermined time after the one traffic participant reaches the first point.
